(19) United States
(12) Patent Application Publication
(10) Pub. No.: US 2007/0070382 A1
(43) Pub. Date: Mar. 29, 2007

(54) Apparatus and method for displaying set driver options

(75) Inventors: Na-young Kim, Suwon-si (KR); Jung-soo Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/502,381

(22) Filed: Aug. 11, 2006

(30) Foreign Application Priority Data
Sep. 23, 2005 (KR) 10-2005-0088680

(51) Int. Cl. G06F 3/12

(52) U.S. Cl. 358/1.13

(57) ABSTRACT

Provided are an apparatus for and method of displaying set driver options. The apparatus includes a selection unit that selects driver options to be displayed; a storage unit that stores the selected driver options; a control unit that sets the stored driver options and stores the set driver options in the storage unit; and a display unit that displays the set driver options. Since set driver options are displayed on a user interface of a printer driver or in a description field of a printer environment setting window, there is no need to open the user interface to view option values set in the printer driver when performing printing operations.

### CROSS REFERENCE TO RELATED APPLICATION

This application claims the priority under 35 U.S.C. § 119(a) of Korean Patent Application No. 10-2005-0088680, filed on Sep. 23, 2005, in the Korean Intellectual Property Office, the entire disclosure of which is hereby incorporated by reference.

### BACKGROUND OF THE INVENTION

1. Field of the Invention

The present invention relates to an apparatus for and method of displaying set driver options. More particularly, the present invention relates to an apparatus for and method of displaying set driver options on a user interface of a driver or in a description field of a printer environment setting window.

2. Description of the Related Art

In a conventional driver, information regarding the status of the driver, the number of documents being printed, and model names can be found in a printer folder.

FIG. 1 illustrates printer information displayed using a printer icon in the conventional driver. Referring to FIG. 1, when a user puts a mouse on a printer icon or right clicks on the printer icon, information regarding a corresponding printer is displayed.

FIG. 2 illustrates printer information displayed in the printer folder of the conventional driver. Referring to FIG. 2, when the user places the mouse on the printer icon or clicks on the printer icon to reverse the printer icon, information regarding a corresponding printer is displayed in a left section of the printer folder.

FIG. 3 illustrates printer information displayed using a host application of the conventional printer driver. The information is stored in a register key HKEY_LOCAL_MACHINE\SYSTEM\CurrentControlSet\Control\Print\Printers\driver model name\Description in a registry of the host application. Thus, when the user desires to view this information, the user should access the register key and display it. However, printer information displayed in an application or a description field in a printer folder of a printer driver is usually not useful to users, and information regarding options set in a printer, which is useful to users, is not displayed. Therefore, a user has to install (or use) an additional driver application to view the details of options set in the printer driver.

Accordingly, a need exists for an improved apparatus for and method of displaying driver options.

### SUMMARY OF THE INVENTION

The present invention provides a method and apparatus for displaying driver options on a user interface of the driver or in a description field of a printer environment setting window. A user does not need to open the user interface to view the driver options when performing a printing operation.

According to an aspect of the present invention, an apparatus for displaying driver options set in a driver includes a selection unit that selects driver options to be displayed, a storage unit that stores the selected driver options, a control unit that sets the stored driver options and stores the set driver options in the storage unit, and a display unit that displays the set driver options.

The selection unit may be implemented as an application or a user interface of the driver.

The storage unit may be a script file or a registry key.

The control unit may create the script files or the registry keys when the set driver options are stored in the storage unit.

The display unit may display the set driver options in a description field of the user interface or in a printer folder in a Control Panel.

The selection unit may include a first window that displays all settabledriver options; a second window that displays the selected driver options; a selection button that is used to select desired driver options in the first window; and a selection-cancel button that is used to cancel some of the driver options displayed on the second window.

According to another aspect of the present invention, a method of displaying driver options set in a driver includes selecting driver options to be displayed, setting some of the selected driver options, storing the set driver options in a storage unit, and displaying the set driver options.

The selecting of the driver options may include selecting the driver options using an application or a user interface of the driver.

The storage unit may be a script file or a registry key.

The storing of the set driver options may further include creating the script files or the registry keys when the set driver options are stored in the storage unit.

The displaying of the set driver options may include displaying the set driver options in a description field of the user interface or in a printer folder in a Control Panel.

The selecting of the driver options may include displaying all settable driver options on a first window, selecting desired driver options in the first window, and displaying the selected driver options on a second window.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 illustrates printer information displayed using a printer icon in a conventional driver;

FIG. 2 illustrates printer information displayed in a printer folder of the conventional driver;

FIG. 3 illustrates printer information displayed using a host application of the conventional printer driver;

FIG. 4 is a block diagram of an apparatus for displaying set driver options according to an exemplary embodiment of the present invention;

FIG. 5 illustrates a selection unit implemented as a host application according to an exemplary embodiment of the present invention;

FIG. 6 illustrates a selection unit implemented as a user interface of a printer driver according to another exemplary embodiment of the present invention;

FIG. 7 illustrates set driver options displayed on a display unit according to an exemplary embodiment of the present invention;

FIG. 8 illustrates set driver options displayed on the user interface of the printer driver, according to an exemplary embodiment of the present invention; and

FIG. 9 is a flowchart illustrating a method of displaying set driver options according to an exemplary embodiment of the present invention.

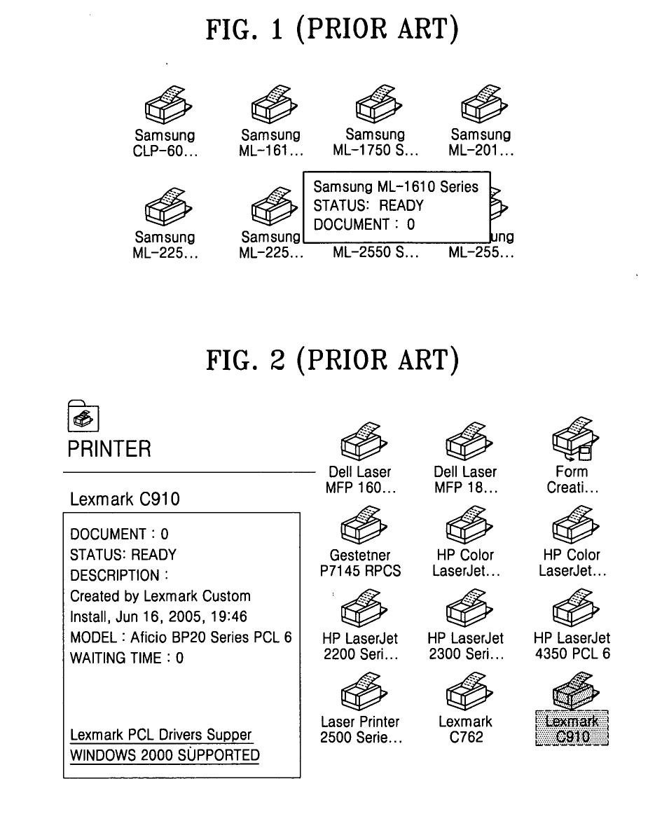

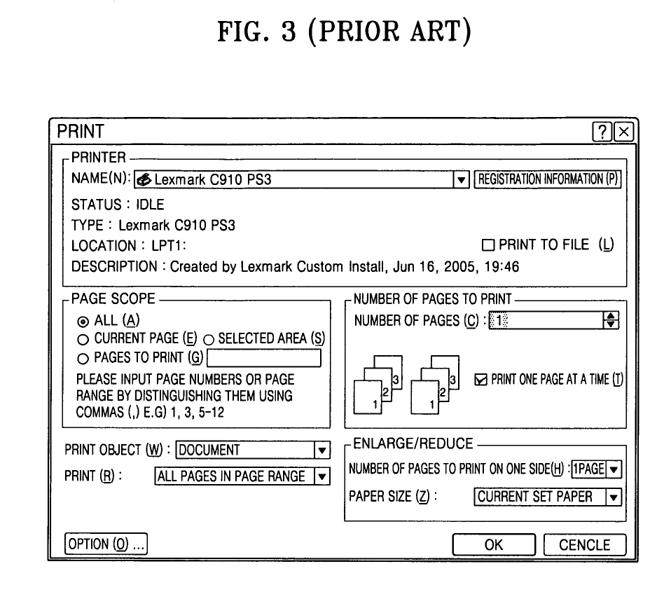

Throughout the drawings, the same drawing reference numerals will be understood to refer to the same elements, features, and structures.

### DETAILED DESCRIPTION OF EXEMPLARY EMBODIMENTS

The present invention is described more fully with reference to the accompanying drawings in which exemplary embodiments of the invention are shown. The invention may, however, be embodied in many different forms and should not be construed as being limited to the exemplary embodiments set forth herein; rather, these exemplary embodiments are provided so that this disclosure is thorough and complete, and fully conveys the concept of the present invention to those skilled in the art.

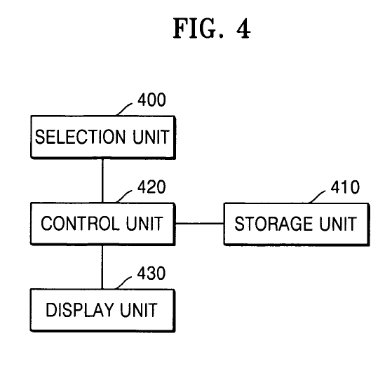

FIG. 4 is a block diagram of an apparatus for displaying set driver options according to an exemplary embodiment of the present invention. Referring to FIG. 4, the apparatus includes a selection unit 400, a storage unit 410, a control unit 420, and a display unit 430.

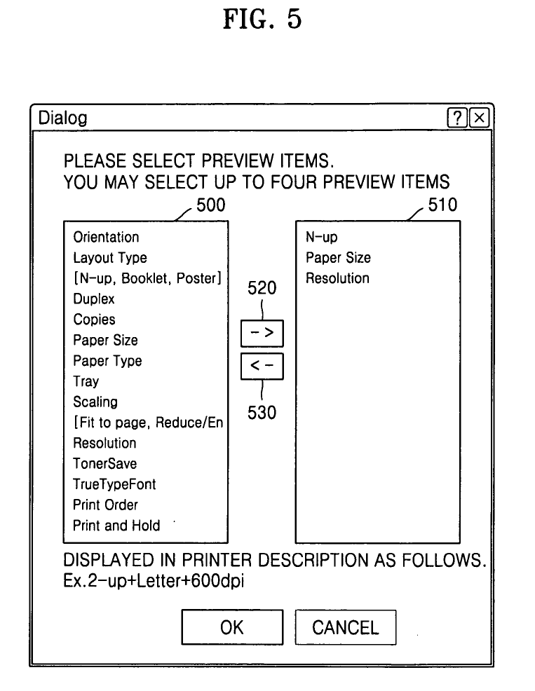

The selection unit 400 selects driver options to be displayed. The selection unit 400 is implemented as a separate host application or a user interface of a printer driver. FIG. 5 illustrates the selection unit 400 implemented as the host application according to an exemplary embodiment of the present invention. Referring to FIG. 5, the selection unit 400 includes a first window 500, a second window 510, a selection button 520, and a selection-cancel button 530.

The first window 500 displays all settable driver options. The second window 510 displays the selected driver options. The selection button 520 is used to select desired driver options in the first window 500. The selection-cancel button 530 is used to cancel selected driver options displayed in the second window 510.

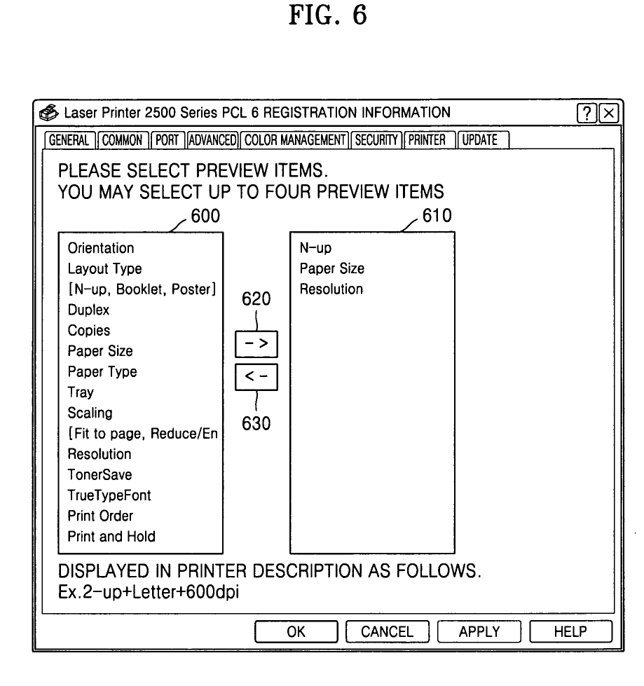

FIG. 6 illustrates the selection unit 400 implemented as the user interface of the printer driver according to another exemplary embodiment of the present invention. The interface of the selection unit 400 of FIG. 5 is substantially identical to that of the selection unit 400 of FIG. 6, except that the selection unit 400 of FIG. 5 is implemented as a separate host application while the selection unit 400 of FIG. 6 is implemented as the user interface of the printer driver. In other words, a first window 600, a second window 610, a selection button 620, and a selection-cancel button 630 included in the selection unit 400 of FIG. 6 have substantially identical configurations and functions as the first window 500, the second window 510, the selection button 520, and the selection-cancel button 530 included in the selection unit of FIG. 5. Thus, a detailed description of the first window 600, the second window 610, the selection button 620, and the selection-cancel button 630 is not repeated.

The storage unit 410 stores driver options. The storage unit 410 is implemented as a file or a registry key. Set driver options are stored in HKEY_LOCAL_MACHINE\SYSTEM\CurrentControlSet\Control\Print\Printers\driver model name\Description in a registry.

The control unit 420 sets driver options and stores the set driver options in the storage unit 410. The control unit 420 creates files or registry keys when the set driver options are stored in the storage unit 410.

The display unit 430 displays the set driver options stored in the storage unit 410. The display unit 430 displays the set driver options in a description field of the user interface of the printer driver.

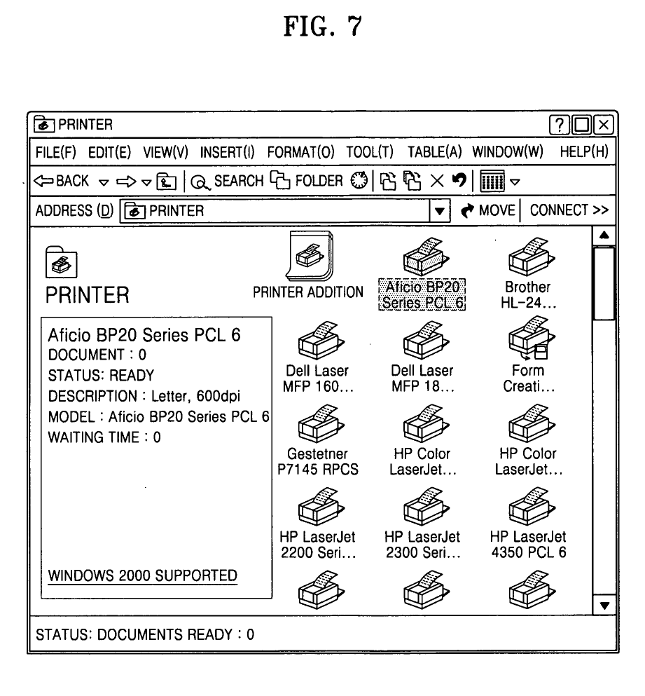

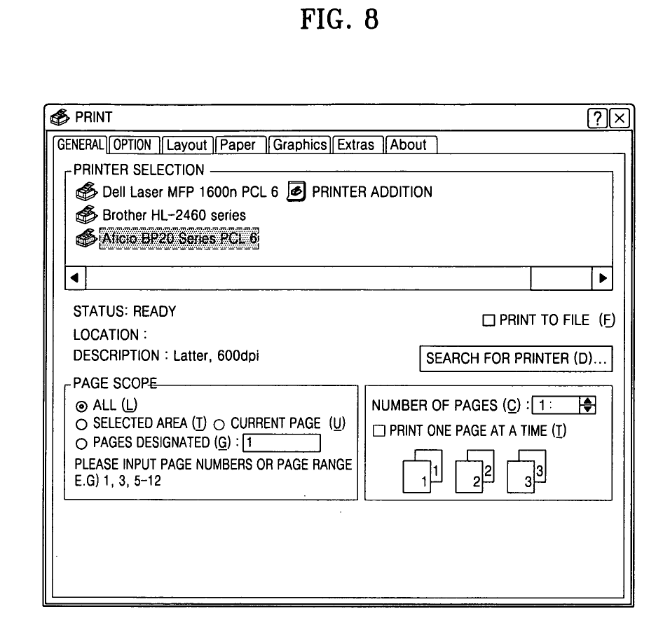

FIG. 7 illustrates set driver options displayed on the display unit 430. FIG. 8 illustrates set driver options displayed on the user interface of the printer driver.

Referring to FIGS. 7 and 8, the set driver options are displayed in a printer folder and in the description field of the user interface of the printer driver. According to the conventional art, useful information is usually not displayed in the description field. However, according to the exemplary embodiments of the present invention, the set driver options, which are useful information for users, may be displayed in the description field.

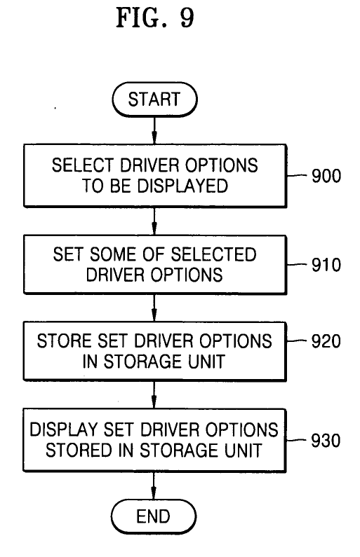

FIG. 9 is a flowchart illustrating a method of displaying set driver options according to an exemplary embodiment of the present invention. The method is described with reference to FIG. 4.

Referring to FIGS. 4 and 9, driver options to be displayed are selected by the selection unit 400 (step 900). The selection unit 400 may be implemented as the host application or the user interface of the printer driver. More specifically, all settable driver options are displayed in the first window 500 (FIG. 5) or 600 (FIG. 6). After desired driver options are selected in the first window 500 or 600, the selected driver options are displayed in the second window 510 (FIG. 5) or 610 (FIG. 6).

A user selects driver options to print from the driver options selected by the selection unit 400 and sets the selected driver options (step 910). The control unit 420 stores the set driver options in the storage unit 410 (step 920). The storage unit 410 may be implemented as a file or a registry key. When the set driver options are stored, files or registry keys are created accordingly.

The control unit 420 displays the set driver options stored in the storage unit 410 on the display unit 430 (step 930). The set driver options are displayed in the description field of the user interface of the printer driver.

According to the exemplary embodiments of the present invention, set driver options are displayed on a user interface of a printer driver or in a description field of a printer environment-setting window. Therefore, there is no need to open the user interface to view option values set in the printer driver whenever a printing operation is performed.

The exemplary embodiments of the present invention may also be implemented as computer-readable code on a computer-readable recording medium. The computer-readable recording medium is any data storage device that stores data that may be thereafter read by a computer system or device. Examples of the computer-readable recording medium include read-only memory (ROM), random-access memory (RAM), CD-ROMs, magnetic tapes, floppy disks, optical data storage devices, and carrier waves (such as data transmission through the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for displaying driver options set in a driver, the apparatus comprising:
a selection unit for selecting driver options to be displayed;
a storage unit for storing the selected driver options;
a control unit for setting the stored driver options and storing the set driver options in the storage unit; and
a display unit for displaying the set driver options.

2. The apparatus of claim 1, wherein the selection unit is implemented as an application or a user interface of the driver.

3. The apparatus of claim 1, wherein the storage unit comprises at least one of a script file or a registry key.

4. The apparatus of claim 3, wherein the control unit creates the at least one of the script files and the registry keys when the set driver options are stored in the storage unit.

5. The apparatus of claim 1, wherein the display unit displays the set driver options in at least one of a description field of a user interface and a printer folder in a Control Panel.

6. The apparatus of claim 2, wherein the selection unit comprises
a first window for displaying at least one of the settable driver option; and
a second window for displaying the at least one selected driver option.

7. The apparatus of claim 2, wherein the selection unit comprises
a first window for displaying all settable driver options; and
a second window for displaying the selected driver options.

8. The apparatus of claim 6, wherein the selection unit comprises
a selection button for selecting the at least one desired driver options displayed in the first window; and
a selection-cancel button for canceling at least one of the selected driver options displayed on the second window.

9. A method of displaying driver options set in a driver, the method comprising:
selecting a driver option to be displayed;
setting the selected driver option;
storing the set driver option in a storage unit; and
displaying the set driver option.

10. The method of claim 9, wherein the selecting of the driver option comprises selecting the driver option using at least one of an application and a user interface of the driver.

11. The method of claim 9, wherein the storage unit comprises at least one of a script file and a registry key.

12. The method of claim 11, wherein the storing of the set driver option further comprises creating at least one of the script file and the registry key when the set driver option is stored in the storage unit.

13. The method of claim 9, wherein the displaying of the set driver option comprises displaying the set driver option in at least one of a description field of a user interface and a printer folder in a Control Panel.

14. The method of claim 9, wherein the selecting of the driver option comprises
displaying at least one of settable driver options in a first window;
selecting a driver option in the first window; and
displaying the selected driver option in a second window.

15. The method of claim 14, further comprising removing a selected driver option displayed in the second window.

16. The method of claim 9, wherein the selecting comprises selecting a plurality of driver options to be displayed.

17. The method of claim 16, wherein the setting step comprises setting the plurality of selected driver options.

18. The method of claim 17, wherein the storing step comprises storing the plurality of set driver options in a storage unit.

19. The method of claim 18, wherein the displaying step comprises displaying the plurality of set driver options.

20. A computer-readable recording medium for displaying driver options set in a driver, comprising:
a first code segment to cause a computer device to prompt selection of a driver option to be displayed;
a second code segment to cause setting of the selected driver option;
a third code segment to cause storing of the set driver option in a storage unit; and
a fourth code segment to cause displaying of the set driver option.

21. A computer-readable recording medium of claim 20, wherein
the first code segment causes a computer device to prompt a user to select a plurality of driver options to be displayed;
the second code segment causes a computer device to set the plurality of selected driver options;
the third code segment causes a computer device to store the plurality of set driver options in a storage unit; and
the fourth code segment causes a computer device to display the plurality of set driver options.
